(19) United States
(12) Patent Application Publication
(10) Pub. No.: US 2026/0222279 A1
(43) Pub. Date: Jul. 30, 2026

(54) ASSESSING GRAY FAILURES IN REAL TIME LOG UPDATES USING LLMS

(71) Applicant: Cisco Technology, Inc., San Jose, CA (US)

(72) Inventors: Akshay Jajoo, San Jose, CA (US); Myungjin Lee, Bellevue, WA (US); Ramana Rao V.R. Kompella, Foster City, CA (US)

(73) Assignee: Cisco Technology, Inc., San Jose, CA (US)

(21) Appl. No.: 19/037,622

(22) Filed: Jan. 27, 2025

(51) Int. Cl. H04L 41/0677; H04L 41/16; H04L 43/04

(52) U.S. Cl. CPC H04L 41/0677; H04L 41/16; H04L 43/04

(57) ABSTRACT

In one implementation, a device assesses, by a troubleshooting agent, log data from a monitored system using a large language model. The troubleshooting agent identifies a failure in the monitored system not indicated by the log data. The troubleshooting agent determines, using the large language model, additional data needed to troubleshoot the failure. The troubleshooting agent causes the monitored system to augment the log data with the additional data for assessment by the troubleshooting agent.

### TECHNICAL FIELD

The present disclosure relates generally to assessing gray failures in real time log updates using large language model (LLMs).

### BACKGROUND

Systems are typically pre-configured to perform static logging whereby the developers of the system write log statements into the code for purposes of log analysis. This allows the system to collect and assess various forms of telemetry of interest, such as to detect failures and other instances of reduced performance in the system. For instance, in the case of a network monitoring system, logs indicative of high packet loss along a network path could be the root cause of users experiencing poor performance when videoconferencing.

With respect to the collection and analysis of log data, a tradeoff exists between collecting too much data and too little. Indeed, collecting, reporting, and analyzing telemetry consumes resources that scale with the amount of telemetry being collected, reported, and analyzed. Conversely, collecting too little telemetry can lead to what are known as ‘gray’ failures whereby there is some indication that a failure condition exists, but the log data is insufficient to reflect that condition. For instance, there may be some indication that a failure condition exists if videoconferencing users are complaining about frozen video, but the system may be unable to recognize that there is a problem if it is due to an overloaded application server that is not reflected in the log data.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrates an example computer network;

FIG. 2 illustrates an example computing device/node;

FIG. 3 illustrates an example of a user interfacing with a language model;

FIG. 4 illustrates an example architecture for an artificial intelligence (AI) agent;

FIG. 5 illustrates an example architecture for assessing gray failures using an AI-based troubleshooting agent; and

FIG. 6 illustrates an example of a simplified procedure for assessing gray failures, in accordance with one or more implementations described herein.

### DESCRIPTION OF EXAMPLE IMPLEMENTATIONS

### Overview

According to one or more implementations of the disclosure, a device assesses, by a troubleshooting agent, log data from a monitored system using a large language model. The troubleshooting agent identifies a failure in the monitored system not indicated by the log data. The troubleshooting agent determines, using the large language model, additional data needed to troubleshoot the failure. The troubleshooting agent causes the monitored system to augment the log data with the additional data for assessment by the troubleshooting agent.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

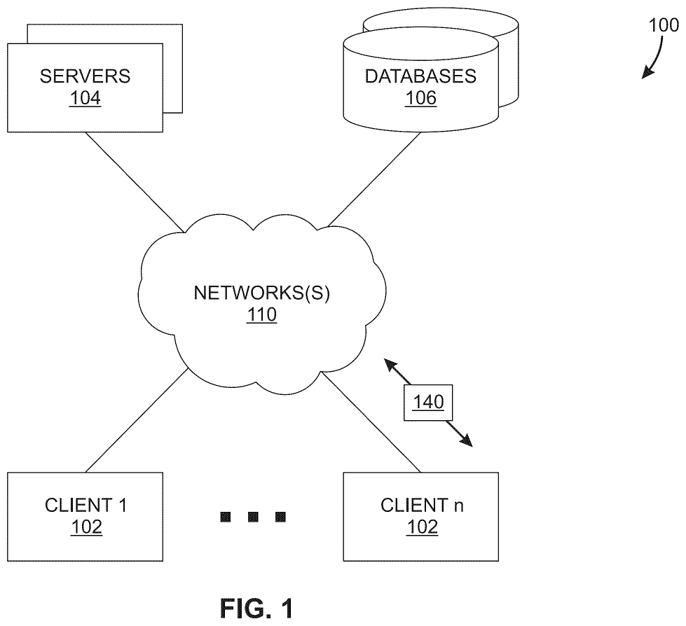

FIG. 1 is a schematic block diagram of an example simplified computing system (e.g., the computing system 100), which includes client devices 102 (e.g., a first through nth client device), one or more servers 104, and databases 106 (e.g., one or more databases), where the devices may be in communication with one another via any number of networks (e.g., network(s) 110). The network(s) 110 may include, as would be appreciated, any number of specialized networking devices such as routers, switches, access points, etc., interconnected via wired and/or wireless connections. For example, client devices 102, the one or more servers 104 and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, the one or more servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art.

Those skilled in the art will also understand that any number of nodes, devices, links, etc. may be used in computing system 100, and that the view shown herein is for simplicity. Also, those skilled in the art will further understand that while the network is shown in a certain orientation, the computing system 100 is merely an example illustration that is not meant to limit the disclosure.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

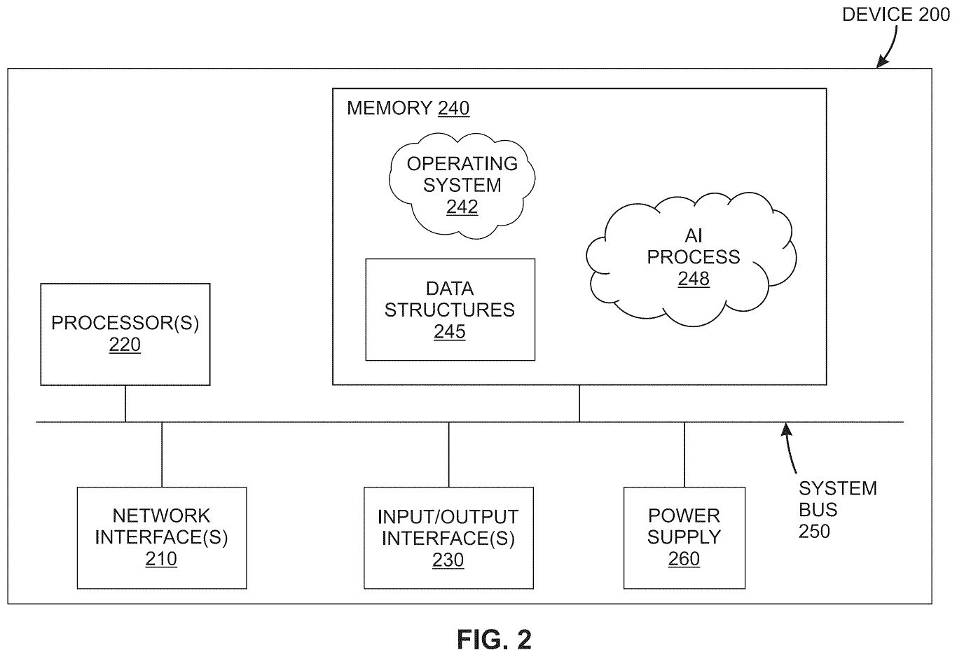

FIG. 2 is a schematic block diagram of an example node/device 200 (e.g., an apparatus) that may be used with one or more implementations described herein, e.g., as any of the devices shown in FIG. 1 above. Device 200 may comprise one or more network interfaces, such as interfaces 210 (e.g., wired, wireless, network interfaces, etc.), at least one processor (e.g., processor 220), and a memory 240 interconnected by a system bus 250, as well as a power supply 260 (e.g., battery, plug-in, etc.).

The interfaces 210 contain the mechanical, electrical, and signaling circuitry for communicating data over links coupled to the network(s) 110. The network interfaces may be configured to transmit and/or receive data using a variety of different communication protocols. Note, further, that device 200 may have multiple types of network connections via interfaces 210, e.g., wireless and wired/physical connections, and that the view herein is merely for illustration.

Depending on the type of device, other interfaces, such as input/output (I/O) interfaces 230, user interfaces (UIs), and so on, may also be present on the device. Input devices, in particular, may include an alpha-numeric keypad (e.g., a keyboard) for inputting alpha-numeric and other information, a pointing device (e.g., a mouse, a trackball, stylus, or cursor direction keys), a touchscreen, a microphone, a camera, and so on. Additionally, output devices may include speakers, printers, particular network interfaces, monitors, etc.

The memory 240 comprises a plurality of storage locations that are addressable by the processor 220 and the interfaces 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes and/or services may comprise an AI process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while processes may be shown and/or described separately, those skilled in the art will appreciate that processes may be routines or modules within other processes.

In various implementations, as detailed further below, AI process 248 may include computer executable instructions that, when executed by processor 220, cause device 200 to perform the techniques described herein. To do so, in some implementations, AI process 248 may utilize AI/machine learning. In general, AI/machine learning is concerned with the design and the development of techniques that take as input empirical data (such as network statistics and performance indicators) and recognize complex patterns in these data. One very common pattern among these techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), the model M can be used very easily to classify new data points. Often, M is a statistical model, and the cost function is inversely proportional to the likelihood of M, given the input data.

In various implementations, AI process 248 may employ and/or be utilized to handle prompts to and/or access of one or more supervised, unsupervised, or semi-supervised AI/machine learning models. Generally, supervised learning entails the use of a training set of data that is used to train the model to apply labels to the input data. For example, the training data may include sample configurations labeled with textual metadata. On the other end of the spectrum are unsupervised techniques that do not require a training set of labels. Notably, while a supervised learning model may look for previously seen patterns that have been labeled as such, an unsupervised model may instead look to whether there are sudden changes or patterns in the behavior of the metrics. Semi-supervised learning models take a middle ground approach that uses a greatly reduced set of labeled training data.

Example AI/machine learning techniques that the AI process 248 can employ and/or be utilized in concert with may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, AI process 248 may also include, or otherwise use or be employed to operate with, one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of machine unlearning, AI process 248 may be a component of, use, and/or be utilized in the management of prompts/access to a generative model to perform layer attribution, perform layer sensitivity assessment, remove capabilities from a previously trained model, retain model performance, etc. based on a conversational input from a user (e.g., voice, text, etc.). Example generative approaches can include, but are not limited to, generative adversarial networks (GANs), large language models (LLMs) and other foundation models, diffusion models, transformer models, and the like.

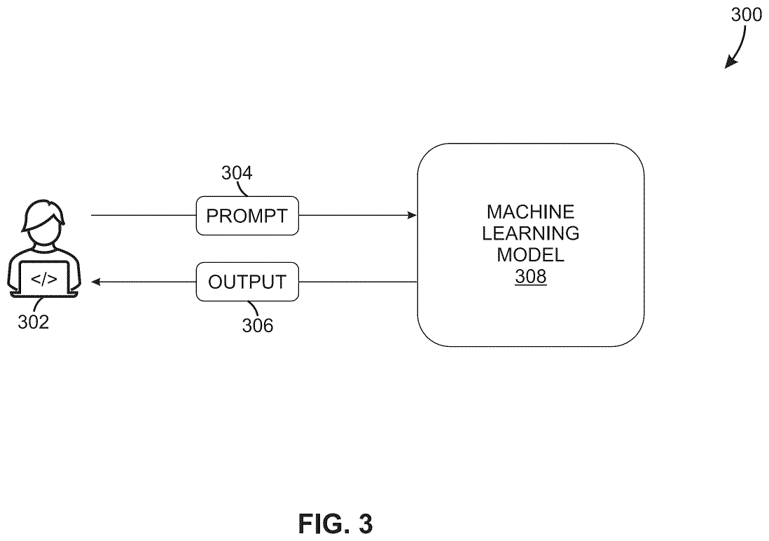

FIG. 3 illustrates an example 300 for interfacing with a language model, in various implementations. In example 300, a user 302 may send a prompt 304 (e.g., a query, a query augmented with additional data, documents, and/or images, etc.) to a generative model 308. The generative model 308 may be configured to process a prompt 304 to generate an output 306 to satisfy the prompt 304.

The generative model 308 may be a model configured to apply its trained algorithms to generate a response (e.g., output 306) based on the prompt 304 provided. For instance, in some cases, generative model 308 may take the form of a large language model (LLM) or other foundation model, diffusion-based model, combinations thereof, or the like.

The output 306 may be the result produced by the generative model 308 (e.g., by the application of the generative model 308 to the prompt 304). This output can vary depending on the model's configuration and the task at hand. For example, the output 306 may include one or more of a generated and/or synthesized image, a text response, a classification and/or prediction, etc.

As noted above, AI agents are also capable of interacting with generative models, such as generative model 308, which may be integrated directly into the agent or accessed via an API. Indeed, the recent breakthroughs in large language models (LLMs), such as GPT-4, as well as other generative models, represent new opportunities across a wide spectrum of industries. More specifically, the ability of these models to follow instructions now allow for interactions with tools (also called plugins) that are able to perform tasks such as searching the web, executing code, etc. In addition, agents can be written to perform complex tasks by chaining multiple calls to one or more LLMs. For example, a first step can consist in formulating a plan in natural language, and subsequent steps in executing on this plan by writing code to call application programming interfaces (APIs) or libraries.

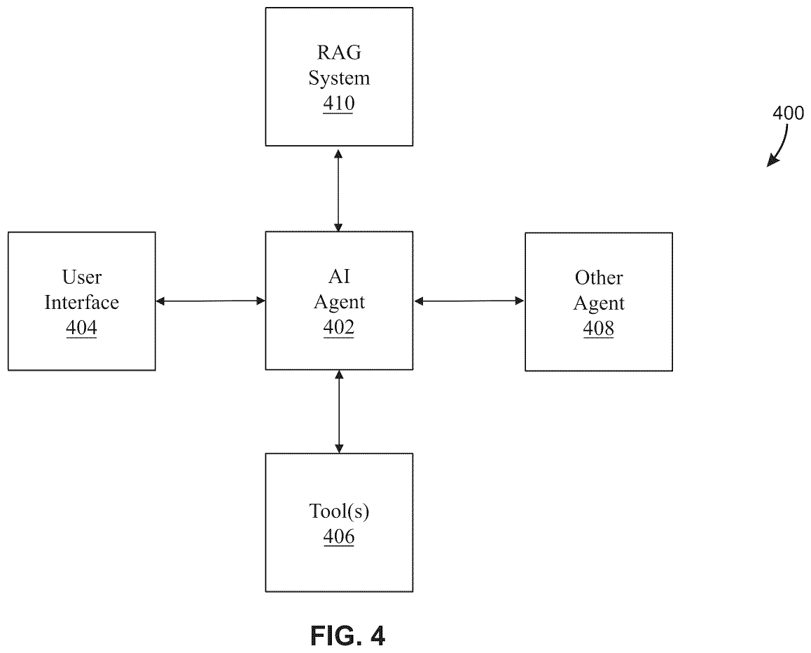

FIG. 4 illustrates an example architecture 400 for an artificial intelligence (AI) agent, according to various implementations. At the core of architecture 400 is AI agent 402, which may be implemented through execution of AI process 248.

As shown, AI agent 402 may interact with a user via a user interface 404. For instance, a user may issue a prompt to AI agent 402 that seeks an answer to a question, performance of a certain task, or the like. In turn, AI agent 402 may use its associated model to formulate a response.

Also as shown, AI agent 402 may interact with tools 406. In general, tools 406 may take the form of interfaces that allow AI agent 402 to interact with any number of systems, in its efforts to produce a response for its input request. For instance, tools 406 may allow AI agent 402 to perform searches (e.g., web searches, searches within a given application or database, etc.), send control commands, or perform other actions, as needed.

In various implementations, AI agent 402 may also be part of an agentic system whereby multiple AI agents interact with one another to formulate a response to an input request. Indeed, the tools, models, etc. available to any given agent may differ across the agentic system. Consequently, different agents may have different capabilities and specialties. Thus, in some implementations, AI agent 402 may also interact with other agent 408, to aid in formulating a final response to its input request. Typically, other agent 408 is executed by a different device than that of the device execution AI agent 402, meaning that AI agent 402 and other agent 408 may communicate via a computer network. In other implementations, though, both agents may be executed by the same device, in further implementations.

For instance, assume that other agent 408 uses a model that has be specialized using knowledge about computer networks and interfaces with tools capable of interacting with a computer network (e.g., to retrieve information, make configuration changes, etc.). Now, assume that the user of user interface 404 issues a query to AI agent 402 asking why the performance of their videoconferencing application is poor. Further, assume that AI agent 402 uses a model that has been specialized on knowledge about the videoconferencing application and able to interact with that application via tools 406. If its initial assessment of the operation of the videoconferencing application is that everything appears to be performing well at the server level, AI agent 402 may then issue a request to other agent 408, to see whether the root cause of the poor performance is the computer network itself.

In some implementations, AI agent 402 may also interact with, or include, a retrieval augmented generation (RAG) system, such as RAG system 410. In general, RAG systems operate by enhancing a prompt for input to a generative model (e.g., an LLM) with additional context. Typically, underlying a RAG system is a dataset of documents or other information that is in a particular domain. For instance, consider the case of AI agent 402 generating a prompt that asks its LLM to make an assessment regarding a computer network. In the case of a general LLM, the LLM may not have specialized knowledge regarding the devices in the network (e.g., command line interface commands, information about the topology of the network, etc.). In such a case, RAG system 410 may modify the prompt, prior to input to the LLM, to provide this additional context, thereby improving the quality of the response and avoiding hallucinations. Typically, a RAG system stores this contextual information in a vector database for quick retrieval using semantic searching.

As noted above, systems are typically pre-configured to perform static logging whereby the developers of the system write log statements into the code for purposes of log analysis. This allows the system to collect and assess various forms of telemetry of interest, such as to detect failures and other instances of reduced performance in the system. For instance, in the case of a network monitoring system, logs indicative of high packet loss along a network path could be the root cause of users experiencing poor performance when videoconferencing.

With respect to the collection and analysis of log data, a tradeoff exists between collecting too much data and too little. Indeed, collecting, reporting, and analyzing telemetry consumes resources that scale with the amount of telemetry being collected, reported, and analyzed. Conversely, collecting too little telemetry can lead to what are known as ‘gray’ failures whereby there is some indication that a failure condition exists, but the log data is insufficient to reflect that condition. For instance, there may be some indication that a failure condition exists if videoconferencing users are complaining about frozen video, but the system may be unable to recognize that there is a problem if it is due to an overloaded application server that is not reflected in the log data.

By way of example, consider the case in which AI agent 402 is configured to ingest log data from a monitored system, such as a computer network, and interact with its LLM to detect and troubleshoot failures in the monitored system. In the context of a computer network, such as failure may correspond to a physical device failing to convey a packet or frame (e.g., a router, switch, access point, etc.), an endpoint failure, a server failure, the network failing to satisfy a service level agreement (SLA) (e.g., based on a packet loss metric, a latency metric, a jitter metric, etc.), failing to satisfy a desired level of quality of service (QoS)/quality of experience (QoE), or any other undesirable condition. Of course, ingesting all possible logs in a computer network is not feasible due to the sheer volume of data. Thus, AI agent 402 may simply be unable to detect all possible failures in the network due to a lack of information in the log data that it ingests.

### Assessing Gray Failures in Real Time Log Updates Using LLMs

The techniques herein allow an AI-based agent to identify ‘gray’ failures using a large language model (LLM). In particular, the techniques herein are able to identify the information needed to be included in the log data generated by the monitored system for detection of the gray failure. In turn, the techniques cause the system to include that information in its generated and reported log data, for further assessment.

Illustratively, the techniques described herein may be performed by hardware, software, and/or firmware, such as in accordance with AI process 248, which may include computer executable instructions executed by the processor 220 (or independent processor of interfaces 210) to perform functions relating to the techniques described herein.

Specifically, according to various implementations, a device assesses, by a troubleshooting agent, log data from a monitored system using a large language model. The troubleshooting agent identifies a failure in the monitored system not indicated by the log data. The troubleshooting agent determines, using the large language model, additional data needed to troubleshoot the failure. The troubleshooting agent causes the monitored system to augment the log data with the additional data for assessment by the troubleshooting agent.

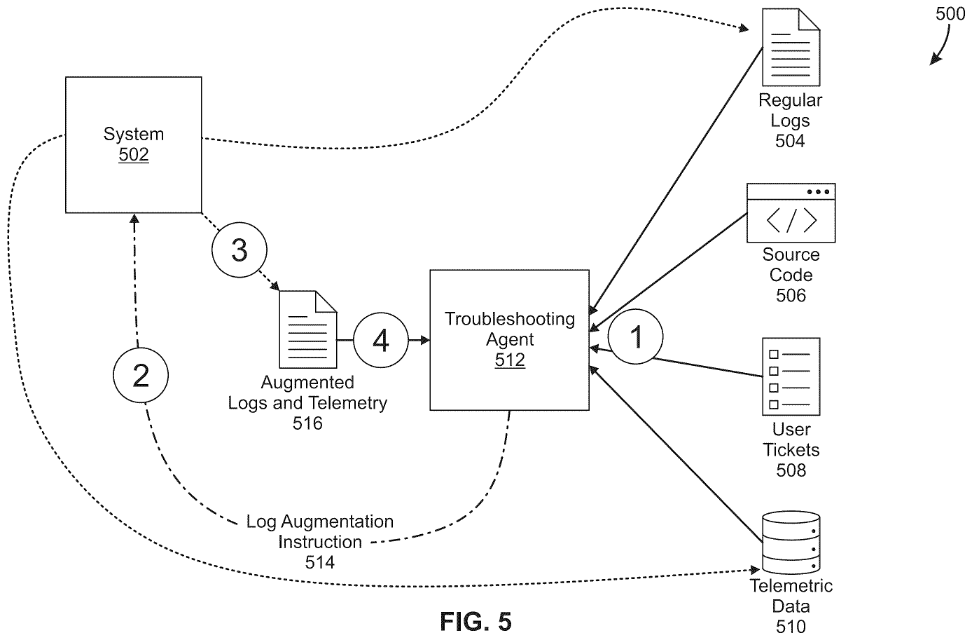

Operationally, FIG. 5 illustrates an example architecture 500 for assessing gray failures using an AI-based troubleshooting agent, according to various implementations. As shown, architecture 500 may include a monitored system 502 and a troubleshooting agent 512 configured to identify and troubleshoot failures in monitored system 502. For instance, monitored system 502 may take the form of a computer network, an industrial system, a vehicle, or any other form of system capable of providing log data in real time for analysis by troubleshooting agent 512.

In various implementations, troubleshooting agent 512 may take the form of an AI-based agent, such as AI agent 402, to assess a stream of information captured and provided by monitored system 502. For instance, in the case of a computer network, monitored system 502 may provide regular logs 504 such as Netflow records, device syslogs, packet capture logs, deep packet inspection (DPI) logs, and the like, to troubleshooting agent 512 for assessment. The log data reported by monitored system 502 may also include telemetric data 510 indicative of performance metrics regarding the network such as, but not limited to, path metrics (e.g., packet loss, jitter, latency, etc.), application-specific metrics (e.g., frame rate, etc.), and the like.

During its normal operation, troubleshooting agent 512 may assess regular logs 504 and telemetric data 510, to determine whether any failures exist within monitored system 502 and, if so, troubleshoot their root causes. Troubleshooting agent 512 may then initiate corrective measures such as by informing an administrator or other user of the root cause, initiating a corrective measure within monitored system 502 (e.g., initiating a routing change, reconfiguring monitored system 502, etc.), or combinations thereof.

In some instances, troubleshooting agent 512 may perform its failure detection functions using one or more LLMs. More specifically, troubleshooting agent 512 may process monitored system 502 and telemetric data 510, to form prompts for input to the LLM. For instance, troubleshooting agent 512 may provide one or more performance metrics from telemetric data 510 to the LLM, asking it to determine whether they are indicative of a failure.

In other instances, troubleshooting agent 512 may rely on heuristics or anomaly detection, to first detect a failure in monitored system 502. For instance, rather than asking the LLM to determine whether a performance metric in telemetric data 510 is acceptable, troubleshooting agent 512 may instead apply an anomaly detector to that metric, to determine whether there are any unexpected changes in its behavior over time. For instance, a sudden spike in packet loss, latency, or jitter could indicate the presence of a failure in monitored system 502.

Regardless of how that troubleshooting agent 512 detects a failure in monitored system 502, it may leverage its associated LLM(s), to troubleshoot that failure. To do so, troubleshooting agent 512 may send one or more prompts based on regular logs 504 and telemetric data 510 to the LLM(s), asking for the cause of the failure. For instance, consider the case in which the packet loss for a particular network path suddenly spikes to nearly 100%. In such a case, troubleshooting agent 512 may provide one or more prompts to its LLM that include regular logs 504 for a router along that path, asking the LLM to determine the root cause of the spike in packet loss. For instance, given regular logs 504 for that path router, the LLM may determine that the router is experiencing an out-of-memory condition, causing it to drop packets.

According to various implementations, troubleshooting agent 512 may also detect when a gray failure exists within monitored system 502, i.e., a failure not currently indicated by its reported log data (e.g., regular logs 504 and telemetric data 510). In some instances, troubleshooting agent 512 may do so based on user-provided information indicative of the gray failure. For instance, this could include any or all of the following:
User tickets 508—for example, support tickets filed by users via an IT support system.
Application feedback—for instance, users may be asked to rate their experience within a given application (e.g., a video conferencing application, etc.)
Other user feedback—for instance, users may complain of issues via instant messaging, corporate chat functions, or the like.
Etc.

In further implementations, troubleshooting agent 512 may take a sue-moto action based on its own analysis of its inputs (e.g., a drop in the metrics being monitored, etc.).

Regardless of the trigger indicative of the presence of a gray failure, troubleshooting agent 512 may then leverage its LLM(s) to identify the additional data needed to identify and troubleshoot that failure. To do so, troubleshooting agent 512 may generate one or more prompts asking the LLM(s) to identify variables or other information not currently being reported by monitored system 502 that are associated with the type of gray failure.

In some implementations, troubleshooting agent 512 may augment its prompt(s) using regular logs 504, source code 506 executed in monitored system 502, user tickets 508 (or other user-provided information), telemetric data 510, or any other information available, to prompt its LLM(s) to identify those variable(s) available in monitored system 502 that could indicate the gray failure and its root cause. For instance, in some instances, troubleshooting agent 512 may use RAG to include information from product documentation, a support ticket resolution database, etc., to enhance its prompts to the LLM(s), to identify what additional data is needed.

For instance, consider the case in which troubleshooting agent 512 does not currently detect any network failures based on the current log data from monitored system 502, but that user tickets 508 indicates that users are reporting that their video conferences keep freezing. In such a case, the LLM of troubleshooting agent 512 may determine that the resource consumptions of the routers along the corresponding network path are currently excluded from the log data reported by monitored system 502.

Once troubleshooting agent 512 has identified the additional data needed to identify and troubleshoot the gray failure, it may provide log augmentation instruction 514 to monitored system 502, thereby instructing it to provide augmented logs and telemetry 516 to troubleshooting agent 512 for further analysis. For instance, in the case of unreported router resources, log augmentation instruction 514 may indicate that such information should be reported to troubleshooting agent 512.

Various possibilities are possible with respect to generating log augmentation instruction 514, including both breadth first and depth first approaches. More specifically, troubleshooting agent 512 may look at the existing logs, source code 506, highlighted/gray failures, and/or other telemetric data, to determine a list of one or more variables that are potentially causes of the gray failure. Call this list [symbol] .

Troubleshooting agent 512 then uses its LLM(s) to evaluate source code 506 and workflow, to identify the next set of variables Θ that includes those variables that can impact [symbol] . The degree of coverage of Θ can be controlled by a parameter, in some implementations.

Troubleshooting agent 512 may decide Θ in various ways such as:
Breadth First—Θ will include all of the variables corresponding to the variables in [symbol] anywhere in source code 506.
Depth First: here, troubleshooting agent 512 may first have to identify the potential point in the workflow/source code where the issue could be arising. Next it may build Θ so as to only include those variables that are relating to variables in [symbol] within the scope of identified points of issue.

Troubleshooting agent 512 may also operate in dynamic manner, thereby verifying that augmented logs and telemetry 516 provide suitable insights into the gray failure. If not, troubleshooting agent 512 may further expands the degree of coverage of Θ, update [symbol] , or switch between breadth first and depth first strategies. In further implementations, troubleshooting agent 512 may also employ the aid of a human expert, asking them to identify further variables that could be related to the gray failure.

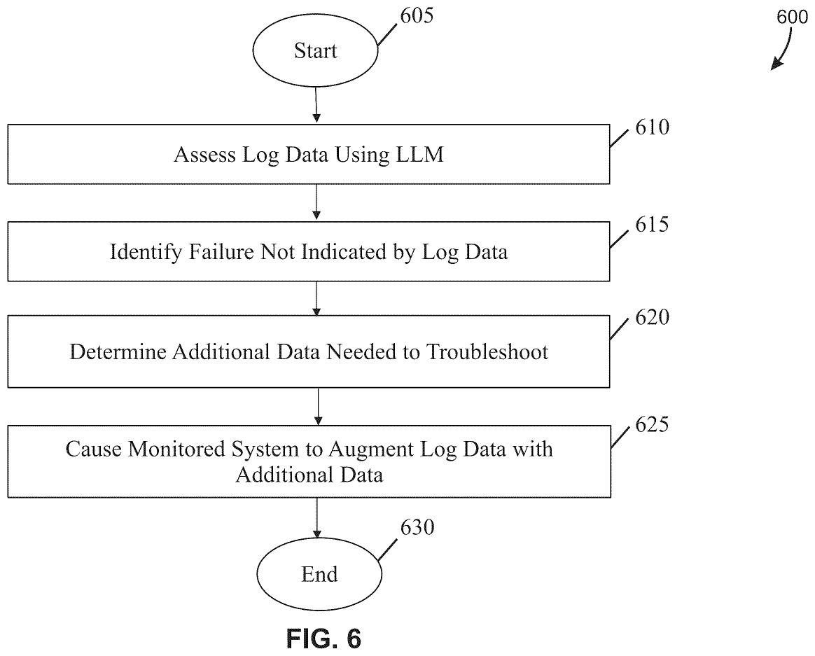

FIG. 6 illustrates an example of a simplified procedure for assessing gray failures, in accordance with one or more implementations described herein. For example, a non-generic, specifically configured device (e.g., device 200), may perform procedure 600 (e.g., a method) by executing stored instructions (e.g., AI process 248). The procedure 600 may start at step 605, and continues to step 610, where, as described in greater detail above, the device (e.g., a controller, server, etc.) may assess, by a troubleshooting agent executed by the device, log data from a monitored system using a large language model. In various implementations, the monitored system is a computer network. In some implementations, the device may do so by providing at least a portion of the log data to the large language model as part of a prompt that requests that the large language model assess the log data to detect any failures in the monitored system.

At step 615, as detailed above, the device may identify, by the troubleshooting agent, a failure in the monitored system not indicated by the log data. In various implementations, the troubleshooting agent identifies the failure based on one or more user-provided indications of the failure. In some cases, the one or more user-provided indications of the failure comprise at least one support ticket.

At step 620, the device may determine, by the troubleshooting agent and using the large language model, additional data needed to troubleshoot the failure, as described in greater detail above. In various implementations, the device may do so by providing, by the troubleshooting agent, source code executed in the monitored system to the large language model. In further implementations, the device may do so by using retrieval augmented generation and information regarding the failure to prompt the large language model to identify the additional data. In one implementation, the troubleshooting agent may determine the additional data by conducting a breadth first search for one or more variables that could indicate presence of the failure using the large language model. In another implementation, the troubleshooting agent may determine the additional data by conducting a depth first search for one or more variables that could indicate presence of the failure using the large language model.

Ats step 625, as detailed above, the device may cause, by the troubleshooting agent, the monitored system to augment the log data with the additional data for assessment by the troubleshooting agent. For instance, in some implementations, the failure is associated with at least one of: a router, a switch, or an access point.

Procedure 600 may then end at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

While there have been shown and described illustrative implementations that provide for assessing gray failures in real time log updates using large language model (LLMs), it is to be understood that various other adaptations and modifications may be made within the intent and scope of the implementations herein. In addition, while certain processes are shown, other suitable processes may be used, accordingly.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true spirit and scope of the implementations herein.

1. A method, comprising:
assessing, by a troubleshooting agent executed by a device, log data from a monitored system using a large language model;
identifying, by the troubleshooting agent, a failure in the monitored system not indicated by the log data;
determining, by the troubleshooting agent and using the large language model, additional data needed to troubleshoot the failure; and
causing, by the troubleshooting agent, the monitored system to augment the log data with the additional data for assessment by the troubleshooting agent.

2. The method as in claim 1, wherein the monitored system is a computer network.

3. The method as in claim 2, wherein determining the additional data needed to troubleshoot the failure comprises:
providing, by the troubleshooting agent, source code executed in the monitored system to the large language model.

4. The method as in claim 1, wherein assessing the log data from the monitored system using the large language model comprises:
providing at least a portion of the log data to the large language model as part of a prompt that requests that the large language model assess the log data to detect any failures in the monitored system.

5. The method as in claim 1, wherein the troubleshooting agent identifies the failure based on one or more user-provided indications of the failure.

6. The method as in claim 5, wherein the one or more user-provided indications of the failure comprise at least one support ticket.

7. The method as in claim 1, wherein determining the additional data needed to troubleshoot the failure comprises:
using retrieval augmented generation and information regarding the failure to prompt the large language model to identify the additional data.

8. The method as in claim 1, wherein determining the additional data needed to troubleshoot the failure comprises:
conducting a breadth first search for one or more variables that could indicate presence of the failure using the large language model.

9. The method as in claim 1, wherein determining the additional data needed to troubleshoot the failure comprises:
conducting a depth first search for one or more variables that could indicate presence of the failure using the large language model.

10. The method as in claim 1, wherein the failure is associated with at least one of: a router, a switch, or an access point.

11. An apparatus, comprising:
one or more network interfaces;
a processor coupled to the one or more network interfaces and configured to execute one or more processes; and
a memory configured to store a process that is executable by the processor, the process when executed configured to:
assess, by a troubleshooting agent executed by the apparatus, log data from a monitored system using a large language model;
identify, by the troubleshooting agent, a failure in the monitored system not indicated by the log data;
determine, by the troubleshooting agent and using the large language model, additional data needed to troubleshoot the failure; and
cause, by the troubleshooting agent, the monitored system to augment the log data with the additional data for assessment by the troubleshooting agent.

12. The apparatus as in claim 11, wherein the monitored system is a computer network.

13. The apparatus as in claim 12, wherein the apparatus determines the additional data needed to troubleshoot the failure by:
providing, by the troubleshooting agent, source code executed in the monitored system to the large language model.

14. The apparatus as in claim 11, wherein the apparatus assesses the log data from the monitored system using the large language model by:
providing at least a portion of the log data to the large language model as part of a prompt that requests that the large language model assess the log data to detect any failures in the monitored system.

15. The apparatus as in claim 11, wherein the troubleshooting agent identifies the failure based on one or more user-provided indications of the failure.

16. The apparatus as in claim 15, wherein the one or more user-provided indications of the failure comprise at least one support ticket.

17. The apparatus as in claim 11, wherein the apparatus determines the additional data needed to troubleshoot the failure comprises:
using retrieval augmented generation and information regarding the failure to prompt the large language model to identify the additional data.

18. The apparatus as in claim 11, wherein the apparatus determines the additional data needed to troubleshoot the failure by:
conducting a breadth first search for one or more variables that could indicate presence of the failure using the large language model.

19. The apparatus as in claim 11, wherein the apparatus determines the additional data needed to troubleshoot the failure by:
conducting a depth first search for one or more variables that could indicate presence of the failure using the large language model.

20. A tangible, non-transitory, computer-readable medium storing program instructions that cause a device to execute a process comprising:
assessing, by a troubleshooting agent executed by the device, log data from a monitored system using a large language model;
identifying, by the troubleshooting agent, a failure in the monitored system not indicated by the log data;
determining, by the troubleshooting agent and using the large language model, additional data needed to troubleshoot the failure; and
causing, by the troubleshooting agent, the monitored system to augment the log data with the additional data for assessment by the troubleshooting agent.
